(19) United States
(12) Patent Application Publication
(10) Pub. No.: US 2004/0158644 A1
(43) Pub. Date: Aug. 12, 2004

(54) Method and apparatus for distributed admission control

(75) Inventors: Celio V. Albuquerque, Encinitas, CA (US); Dennis P. Connors, San Diego, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Magis Networks, Inc., San Diego, CA (US)

(21) Appl. No.: 10/365,266

(22) Filed: Feb. 11, 2003

(51) Int. Cl. G06F 15/173

(52) U.S. Cl. 709/238; 709/224

(57) ABSTRACT

The present invention advantageously addresses the needs above as well as other needs through a method and apparatus for providing distributed admission control for a communication network. The method and apparatus are configured to receive new flows at a terminal and determine at the terminal the amount of resources available to the terminal. The terminals accept new flows if there are sufficient available resources and deny new flows if there is insufficient available resources. The method and apparatus further manage the bandwidth for flows of the communication network from an access point. The access point includes a bandwidth manager which reserves bandwidth for flows if there is available time within communication frames.

### BACKGROUND

1. Field of the Invention

The present invention relates generally to the optimization of throughput in a communication system, and more specifically to the optimization of throughput through distributed resource allocation for shared medium communication.

2. Discussion of the Related Art

Communication networks typically need some way to control admission of new traffic flows to the network. FIG. 1 depicts a distributed communication network 120 having a central access point (AP) 122 coupled with a plurality of terminals 124a-g. Each terminal 124a-g can further couple with one or more of the other terminals. Data and other information are supplied to and from the terminals through the AP 122 or through the other terminals. The data or information can include substantially any type of information including voice, text, graphics, multimedia (e.g., pay-per-view movies, TV programs, Internet video, camcorder video transmissions, MP3 audio, and voice flow) and other information. The data is communicated across links 126. A link allows one or more flows of information to utilize that link.

Most previous shared medium communication networks, such as Ethernet and 802.11 Wireless LANs, have no explicit admission control mechanism and therefore any amount traffic is accepted into the network. If there are no resources available, the network becomes congested, data is lost and the quality of the communication significantly degrades.

In more advanced previous systems, admission to all traffic coming into (and/or through) the network is controlled by the central AP 122. For each flow of each link, the amount of information within each flow and the rate of data transfer are all processed at one central location, which decides whether the flow can or cannot be admitted into the network. This requires a large amount of processing to be performed by the AP 122 to maintain control of the system 120. Further, this large amount of processing creates a communication bottleneck, which slows down the ability of the network to optimize communication. A centralized admission control network requires the AP to keep track of each terminal's traffic load and of the network's overall load. The traffic load flowing to and from a terminal may vary significantly over time and in a centralized admission control network, changes in the traffic load need to be continuously communicated to the AP.

### SUMMARY OF THE INVENTION

The present invention advantageously addresses the needs above as well as other needs through a method and apparatus for providing distributed admission control for a communication network. The method and apparatus are configured to receive new flows at a terminal and determine at the terminal the amount of resources available to the terminal. The terminals accept new flows if there are sufficient available resources and deny new flows if there is insufficient available resources. The method and apparatus further manage the bandwidth for flows of the communication network from an access point. The access point includes a bandwidth manager which reserves bandwidth for flows if there is available time within communication frames.

### BRIEF DESCRIPTION OF THE DRAWINGS

The above and other aspects, features and advantages of the present invention will be more apparent from the following more particular description thereof, presented in conjunction with the following drawings wherein:

FIG. 1 depicts a previous distributed communication network having a central access point (AP) coupled with a plurality of terminals;

FIG. 2 depicts a distributed communication network 150 including an AP, a plurality of distributed terminals, and a distributed admission control (AC) system;

FIG. 3A depicts a simplified block diagram of an AP in accordance with one implementation of one embodiment of the present invention;

FIG. 3B depicts a simplified block diagram of an terminal in accordance with one implementation of one embodiment of the present invention;

FIG. 4 depicts a flow diagram of one implementation of the operation of a flow registration unit (FR);

FIG. 5 depicts a flow diagram of one embodiment of a method for determining if a bandwidth request can be satisfied and reserving bandwidth;

FIGS. 6A-C depict examples of portions of a plurality of sequential frames for a flow being transmitted across a link;

FIGS. 7A-B depict flow diagrams of methods for reallocating bandwidth for flows utilizing a link which has undergone a change in link speed or change in frame allocation;

FIG. 8A depicts a graphical representation of the communication of information though a previous system; and

FIGS. 8B-C depict graphical representations of the communication of information though the present inventive communication network.

Corresponding reference characters indicate corresponding components throughout the several views of the drawings.

### DETAILED DESCRIPTION

The following description is not to be taken in a limiting sense, but is made merely for the purpose of describing the general principles of the invention. The scope of the invention should be determined with reference to the claims.

The present invention provides a method and apparatus for distributed admission control to optimize the allocation of network resources. The present invention optimizes communication across communication links by in part distributing processing resources. The distribution of admission control processing significantly reduces, and in many configurations eliminates the bottleneck effects of network control as seen in previous communication systems. The distribution of processing reduces the amount of processing overhead any single component is required to perform, which provides increased response times and an increased rate at which data, information and/or signals can be communicated. Additionally, the present invention utilizes a priority scheme to further optimize communication, thus giving more time sensitive data and/or information priority to improve the accuracy of the data and information. The present invention provides distributed admission control of network resources for the communication of substantially any type of data and information including, but not limited to, multimedia information (i.e., television, video, music, graphics, movies), voice data, electronic information (i.e., E-mails, facsimile data, Internet data, and other such information), and substantially any other type of data and information. The terms data and information are be used interchangeably throughout the application; however, both are to be construed to include any data, information and/or signals capable of being communicated over a channel, where a channel is a medium on which data, information and/or signals are carried in a communications system.

The distributed admission control is configured to accept, deny and reassign network resources to new and existing flows. A flow is a sequence of packets which have sequential dependence on one-another, originate from the same source, and/or carry a common information stream. A packet is a unit of data, information and/or signal that is transmitted on a communications channel. Additionally, the distributed admission control allocates network resources to various classes of traffic flows. The functionality of the admission control includes flow registration, bandwidth reservation and bandwidth renegotiation. The admission control interacts with other modules of the communications network to obtain load conditions of the network and the speed of the network links.

In one embodiment, the present invention allocates the network resources, at least in part, based on various traffic flow classifications. The quality of the service (QOS) provided to the flows depends on the nature and priority of the traffic. At least two main classes of traffic are supported, real-time and non-real-time traffic. Real-time traffic is characterized by either constant bit rate (CBR) or variable bit rate (VBR) traffic, and non-real-time traffic has an unspecified bit rate (UBR) traffic. Traffic flows may have various priorities, where real-time flows are generally assigned higher priority than non-real-time flows. Further there may be various priorities of different real-time flows and various priorities of different non-real-time flows. For example in real-time flows, real-time multimedia flows such as pay-per-view movies, TV programs, Internet videos, camcorder video transmissions, MP3 audio, voice flows and other such multimedia flows may each be assigned different priorities. Generally, the priority of a flow defines a QOS provided to the flow. One example of a mapping between traffic classes and the QOS provided to those classes is shown in Table 1.

TABLE 1
Mapping of Classes of traffic and Delivered quality of service

| Class of | | | |
|---|---|---|---|
| Traffic | Application | Traffic | QOS |
| Real-time | Sustained | CBR | Bandwidth guaranteed |
| | Multimedia | Constant bit | |
| | | rate | |
| | Bursty | VBR | Minimum bandwidth |
| | Multimedia | Variable bit | guaranteed, |
| | | rate | excess traffic may |
| | | | use the available |
| | | | bandwidth |
| Non-real- | Data | UBR | Available bandwidth |
| time | | Unspecified | |
| | | bit rate | |

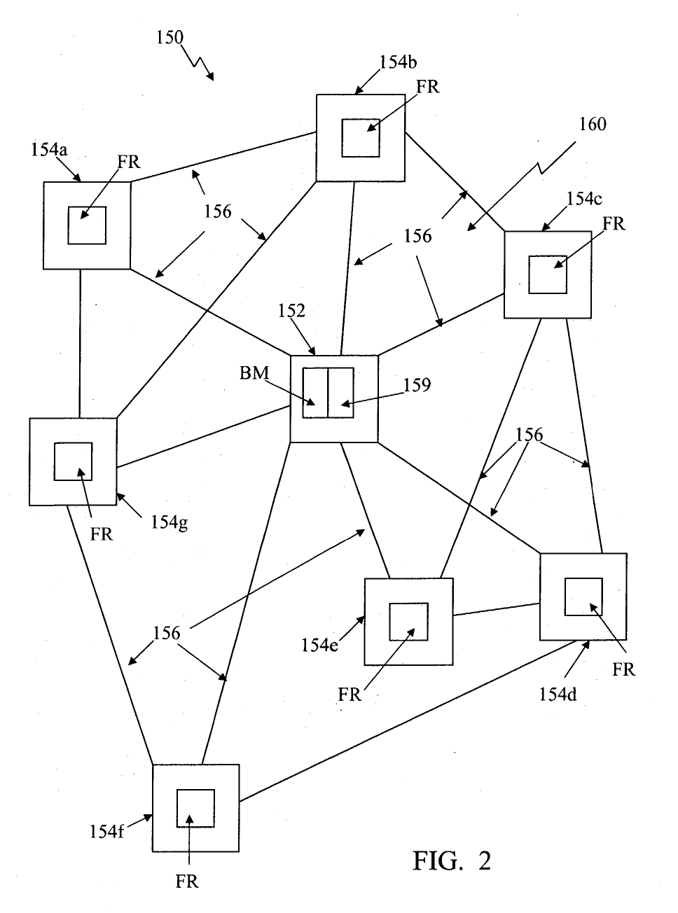

FIG. 2 depicts a distributed communication network 150 including an access point (AP) 152, a plurality of distributed terminals 154a-g, and a distributed admission control (AC) system 160. The terminals are preferably geographically distributed; however, one or more terminals can coexist in a single location. Further, the AP can be configured to include one or more terminals. Still further, the geographical distribution does not require large distances. As examples, terminals can be different devices within a single dwelling (for example, computer(s), television(s), stereo(s) and other appliances within a home), the terminals can be located at different buildings of a campus, different floors of a building, different offices in different cities of a corporation, and other such configurations.

The network 150 is configured to provide communication between the AP 152 and the terminals 154a-g. Additionally, each terminal can be configured to communicate with one or more of the other terminals. Communication between the AP and the terminals, as well as between the terminals, is performed over links 156. Each link is configured to provide one or more flows of communication, and are generally bi-directional but can be one directional. The links can be established through substantially any type of communication channel including: direct coupling, such as coaxial cable, twisted wired pairs, fiber optics and other such direct coupling; non-direct coupling, such as telephone lines and the Internet; wireless communication, such as RF, cellular, optical and other such wireless communication; and substantially any channel for communication.

In one embodiment, the network further includes a bandwidth management protocol 159. The bandwidth management protocol provides communication of bandwidth management messages between the terminals and the access point. Terminals exchange bandwidth management messages with the AP when requesting bandwidth reservation or when releasing bandwidth. The AP bandwidth manager may accept or deny the bandwidth reservation. Furthermore, due to changes in link quality, the AP may release the bandwidth allocated to any terminal.

In one embodiment, bandwidth management protocol operates as follows:

1. When a terminal wishes to reserve bandwidth for a given flow, it sends a bandwidth reservation request message to the AP, containing the desired bandwidth amount;

2. The AP calculates if there's enough bandwidth available in the network and sends a Bandwidth reservation response message to the terminal;

3. When a terminal's flow becomes inactive, or when a terminal wishes to release a previously reserved bandwidth, it sends a bandwidth release request message to the AP; and

4. The AP confirms the bandwidth has been released by sending a bandwidth release response message to the terminal.

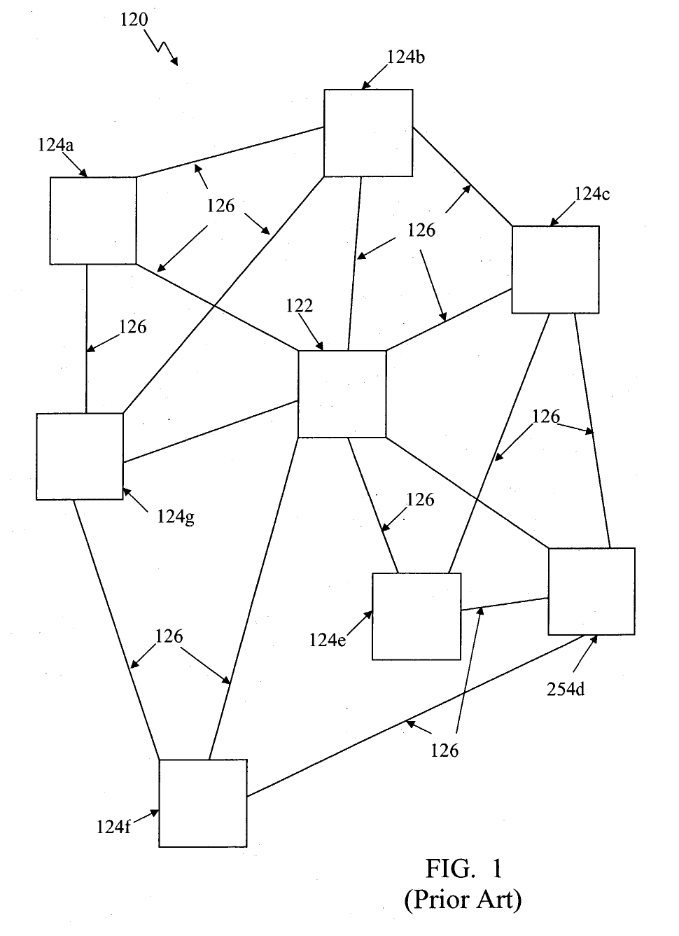

The AC system 160 allocates network resources for traffic flows, including providing communication control over the links 156 by, in part, accepting and denying new flows, reserving bandwidth, organizing communication frames, and determining link speed. The AC system 160 is distributed through the AP 152 and at least one, and preferably a plurality of the terminals 154a-g. The AC system 160 provides for the distributed processing in allocating network resources. The distribution of processing reduces and substantially eliminating the communication bottle neck occurring in previous communication systems as a result of the single central access point (see FIG. 1).

In one embodiment, the distributed AC system 160 is organized as two functional subsystems or levels, a centralized bandwidth manager (BM) operating from the access point (AP) 152 and one or more flow registration units (FR) operating from the plurality of terminals 154a-g. The BM monitors the available bandwidth in the network 150 and reserves bit rate bandwidths for flows. The FRs accept or deny the admission of new flows into the network 150. The admission of a new flow is based, at least in part, on the traffic load of the terminal from which the FR is operating. In one embodiment, the AP can also include an FR if the AP operates in dual mode as an AP as well as a terminal. In another embodiment, each terminal does not include an FR. One or more terminals share an FR. An FR can be a separate component of the network 150 and provide resource allocation to one or more terminals accessing the remote FR.

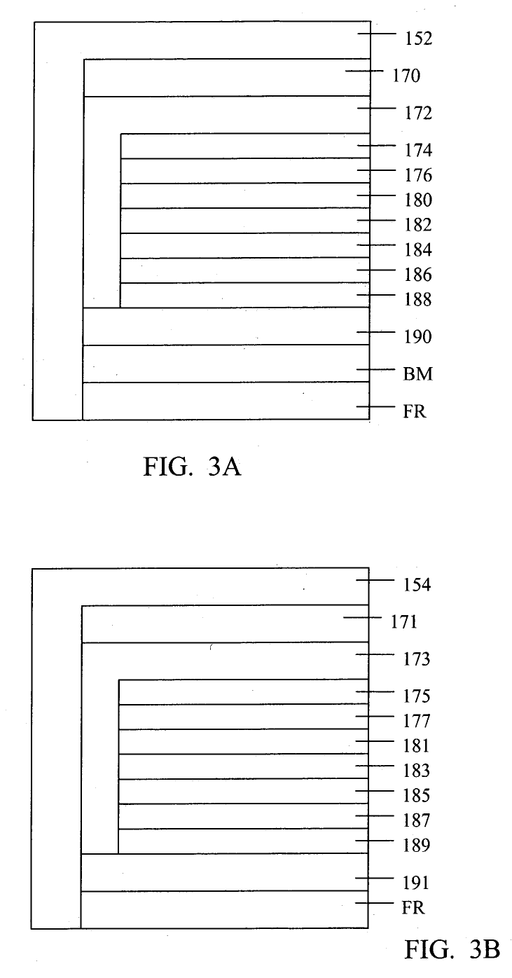

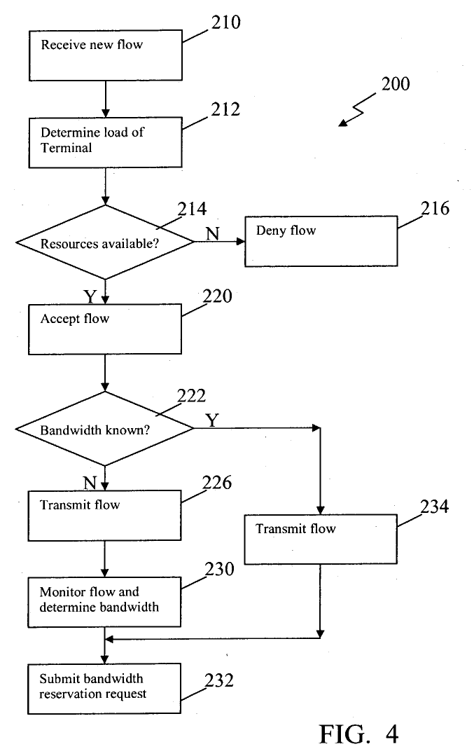

FIG. 3A depicts a simplified block diagram of an AP 152 in accordance with one implementation of one embodiment of the present invention. The AP includes a processor or controller 170 which is implemented through a state machine, a computer, a micro-processor or substantially any other controller known in the art. The AP further includes a memory 172 for storing data 174, communications 176, control procedures 180, applications 182, tables 184, protocols 186 and other data, parameters and processes 188 utilized by the AP. The AP also includes the BM, and in one embodiment, includes an FR. A communication port 190 is included within the AP to provide communication between the AP and the terminals, as well as the AP with other components (not shown) of the network 150 or other external networks (not shown) coupled with network 150, such as the Internet or other communication networks. The communication port can be substantially any communication port known in the art for providing communication including a transceiver for wireless communication, a modem, an Ethernet port, an optical communication port and substantially any other communication port.

FIG. 3B depicts a simplified block diagram of a terminal 154 in accordance with one implementation of one embodiment of the present invention. The terminal includes a processor or controller 171 which is implemented through a state machine, a computer, a micro-processor or substantially any other controller known in the art. The terminal further includes a memory 173 for storing data 175, communications 177, control procedures 181, applications 183, tables 185, protocols 187 and other data, parameters and processes 189 utilized by the terminal. The terminal 154 also includes the FR. A communication port 191 is included within the terminal to provide communication between the terminal and the AP and other terminals, as well as with other components (not shown) of the network 150 or other external networks (not shown) coupled with network 150, such as the Internet or other communication networks. The communication port can be substantially any communication port known in the art for providing communication including a transceiver for wireless communication, a modem, an Ethernet port, an optical communication port and substantially any other communication port.

The FRs perform flow registration locally on each of their respective terminals. Distributing the FRs on the terminals provides for the distribution of the resources to provide communication control for the network 150. An FR accepts or denies flows based on terminal load. In registering flows, the FR additionally allocates resources in the terminal for the flow. The resources allocated include, but are not limited to, memory for in-bound and out-bound information buffers; for storing flow information such as the flow identifier, destination address, priority, type of traffic, bandwidth, throughput, packet loss rate, link quality and the like; and for issuing bandwidth allocation requests to the BM.

The FR utilizes at least a current terminal load and a flow specification in determining resource allocation. The flow specification includes at least a flow identification (FID) and a flow priority. In one embodiment, the FR maintains and updates a flow registration table based on the flows accepted by the FR and the resources allocated for the flows. The registration table includes the FID and the priority of the flow, and may additionally include the amount of memory utilized, the bandwidth reservation if available, the portion of a frame allocated for each flow, and other relevant information. In one embodiment, the present invention issues higher priorities to some types of traffic over other types, or may provide higher priority to traffic addressed to certain destination addresses (e.g., a certain terminal). As such, the registration table can also maintain the type of traffic (voice, video, computer data, and the like) and destination addresses. Table 2 shows one example of the registration table and the information maintained in the registration table.

TABLE 2
Registration Table

| FID | Priority | Memory use | BW Res. | Fame Alloc. |
|---|---|---|---|---|
| 01 | A1 | XX | XX | XX |
| 02 | B1 | XX | XX | XX |
| 03 | E1 | XX | XX | XX |

In one embodiment, the FID is made up of two entries: a type of service (TOS) indicator, and a flow number. The FID is used to uniquely identify the packets of each flow. The TOS indicator identifies the priority of the flow, which is often related to the type of application producing the flow, for example, voice, video, data, and the like. The flow number identifies a particular flow within a TOS category. For example, the flow number is used to distinguish flows having the same TOS indicator.

The TOS provides a means for prioritizing flows when optimizing the bandwidth of a frame. The flow number and TOS allow the admission control system to optimize individual flows and to prioritize bandwidths for flows.

FIG. 4 depicts a flow diagram of one implementation of a method 200 for operating an FR. In step 210, a new flow is received by the terminal. The new flow can originate from the AP, the terminal from which the FR operates or an alternate terminal. In step 212, the FR determines the current load of the terminal. In determining the load, the FR checks the available memory of the terminal and/or the number of packets waiting for transmission from the terminal. In step 214, the FR determines if sufficient resources are available in the terminal to accept the flow. If the resources are not available, step 216 is entered where the FR denies resources to the flow. If the resources are available, step 220 is entered where the flow is accepted. In step 222, the FR determines if bandwidth requirements for the flow are known (for example, the bit rate is often known when the flow consists of constant bit rate data). If the bandwidth requirements are known, the method proceeds to step 234 where the FR begins transmission of at least a portion of the flow. Following step 234 step 232 is entered where the FR submits a bandwidth reservation request to the BM. If the bandwidth requirements are not available, the FR prepares for data transmission based on the priority of the flow in step 226. In step 226 the FR transmits at least a portion of the flow regardless of whether bandwidth has been reserved or not. If in step 222, the bandwidth is not known, step 230 is entered where the FR monitors the flow to determine the needed bandwidth (further described below). In step 232 the FR submits a bandwidth reservation request.

In one embodiment, the FR utilizes a flow registration release. When the flow is terminated or no longer needs the resources, or if the terminal detects that the flow is idle, the terminal issues a release to the FR. Upon receiving the release, the FR releases the flow resources and returns a flow release confirmation.

In one embodiment, the BM operates from the AP 152 and is configured to perform bandwidth reservations and manage a reservation table. In utilizing the reservation table, the network 150 is capable of optimizing available bandwidth for link communications.

Upon receiving a bandwidth request from an FR, the BM determines if there is available bandwidth to satisfy the request. The request is forwarded from the FR to the BM and includes, at least an FID and the number of bytes per second requested, and preferably further includes a flow priority and a link speed defining a maximum speed packets can be transmitted over the link. The rate of transmission is defined for a link, thus flows operating from a single link will have the same transmission rate. The BM calculates a number of packets to be transmitted per frame and a time needed to satisfy the request based on the link speed of the flow. The BM further determines the available time in the communication frame, such as a TDMA frame. The BM determines if the request can be satisfied based, at least in part, on the number of packets per frame to be transmitted, the link speed and the available time in the frame.

In one embodiment, flows having bandwidths reserved may be temporarily halted or rejected and loose their reserved bandwidths for one or more frames to accommodate flows having higher priorities. Additionally, low priority flows may be completely dropped loosing their reserved bandwidth to higher priority flows and have to resubmit bandwidth requests or to transmit on a best-effort mode obtaining bandwidth when available. When flows transmit on a best-effort mode, bandwidth is not reserved for the flow, and data is only transmitted when the network bandwidth is not being used by other terminals. In best effort mode, no guarantees can be made regarding the flow's throughput or its packets delays. Best-effort mode can be used for computer data traffic, but typically it will not perform well for time-sensitive applications such as video and voice traffic.

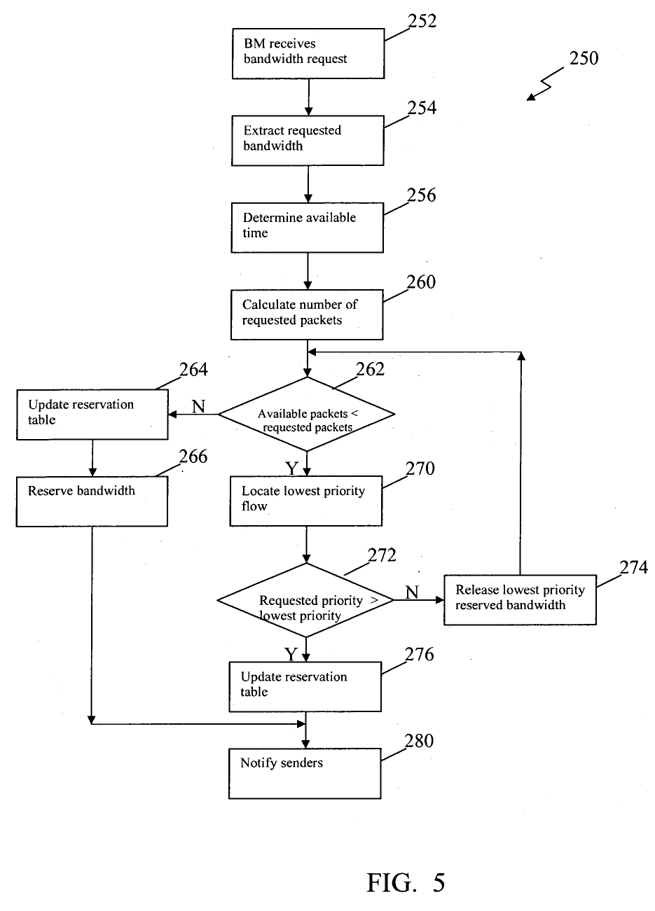

FIG. 5 depicts a flow diagram of one embodiment of a method 250 for determining if a bandwidth request can be satisfied and reserving bandwidth. In step 252, a bandwidth request is received by the BM from an FR. In step 254, the BM determines the amount of requested bandwidth and the link speed of the flow requesting the bandwidth. In step 256, the BM determines the available time in the communication frame. In step 260, the BM calculates the requested number of packets to be communicated per frame and the number of packets available per frame. In step 262, it is determined if the available packets per frame are less than the requested number of packets per frame. If the requested number of packets does not exceed the available packets, the method proceeds to step 264 where the BM updates the reservation table with the requested number of packets per frame, then step 266 is entered where the bandwidth is reserved to satisfy the request.

If, in step 262, the available packets are less than the number of requested packets, step 270 is entered where the BM locates a flow with reserved bandwidth that has the lowest priority of the flows having reserved bandwidths. In step 272, it is determined if the priority of the flow requesting bandwidth is greater than the priority of the lowest priority flow. If the priority of the flow requesting the bandwidth is greater than the priority of the lowest priority flow, then step 274 is entered. In step 274, the BM releases the reserved bandwidth allocated to the lowest priority flow, updates the reservation table, updates the available time in the frame, and recalculates the available packets in the frame.

The method 250 then returns to step 262 where it is determined if the number of available packets is less than the number of requested packets. If the number of available packets is greater than the requested number of packets, the method then proceeds to step 264 to allocate the requested bandwidth. If the number of available packets is less the number of requested packets, the method returns to steps 270 and 272 to determine if other lower priority flows can be released to free up bandwidth.

If, in step 272, it is determined that the lowest priority flow having reserved bandwidth has a priority greater than that of the priority of the requested bandwidth, then step 276 is entered. In step 276, the reservation table is updated to include freed up bandwidth if lower priority flows were previously released in step 274 in an attempt to satisfy the requested bandwidth.

In one embodiment, step 274 does not release the lowest priority flow until it is determined that a sufficient amount of packets can be made available to satisfy the request in step 262. In this embodiment, step 264 further releases all those lower priority flows that were determined in step 272 to have a lower priority than the requesting flow and were needed to satisfy the request.

Following steps 266 and 276, the method proceeds to step 280 where the sender of the flow requesting bandwidth is notified of the confirmation or rejection of the bandwidth request. Further, in step 280, the senders of any flows which were released in attempting or in satisfying the bandwidth request are notified of the release of bandwidth. In one embodiment, the bandwidth management protocol 159 (see FIG. 2) generates and forwards the bandwidth request confirmation or rejection, as well as the notification to any sender of any bandwidths released.

When a bandwidth reservation request is received by the BM, the BM calculates the number packets per frame (see step 260, FIG. 5). In one embodiment, the reservation is received by the BM as a request based on a number “R_{B}” of bytes per “R_{I}” seconds. The BM converts the bytes per second into “R” number of packets per frame. Equation 1 below is one implementation for providing the conversion to R packets per frame:

$$R = \frac{{R}_{B} * Frame\_Length}{{R}_{I} * packet\_size} \qquad Eq . 1$$

Often, the resulting R packets per frame do not result in a whole number of packets per frame, but include some fractional portion of a frame, for example R=4.3 packets per frame. The fractional result would require previous applications to perform floating point operations. Further, previous applications require an over compensation of bandwidth to satisfy the packets per frame by rounding the number of packets per frame up to the next whole number for each frame to ensure sufficient bandwidth. This results in a large amount of wasted bandwidth. For example, if R=4.3, previous applications would round up to 5 packets per frame, resulting in a wasted 0.7 packet per frame.

In several embodiments, the present invention significantly reduces, and in some cases substantially eliminates, this wasted bandwidth. The present invention is capable of achieving this efficient bandwidth allocation by matching the reserved bandwidth and the requested bandwidth by allowing the number of packets reserved for a flow to vary from frame to frame.

The reservation table maintained by the BM is configured to store for each flow at least four fields: a flow specification having a FID and priority; a flow link speed; a maximum allocation for a flow (A); and a base allocation (B) equaling a base number of packets to be transmitted per frame. The reservation table may additionally include at least three variables for each flow, including: an Interval (I) designating a number of frames after which the Base Allocation (B) should be incremented or decremented; a transmission counter (TC) configured to count the number of frames transmitted since the last increment or decrement of the base allocation; and an Increment/Decrement flag (F) that indicates whether the base allocation should be incremented or decremented when the transmission counter reaches the Interval value (I).

Table 3 shows one example of one implementation of a reservation table. The embodiment of the reservation table shown in Table 3 further includes an additional parameter designating an Allocated Bandwidth (ABW), which is not a required parameter.

TABLE 3
Reservation Table

| FID/ | Link | Allocation | (B) Base | Interval | | | |
|---|---|---|---|---|---|---|---|
| priority | Speed | (A) | Allocation | (I) | TC | F | ABW |
| 1 | 12 Mbps | 6 | 5 | 5 | 0 | INC | 5.2 |
| 2 | 6 Mbps | 3 | 2 | 3 | 1 | INC | 2.33 |
| 3 | 32 Mbps | 3 | 3 | 3 | 1 | DEC | 2.67 |
| 4 | 54 Mbps | 10 | 10 | 10 | 7 | DEC | 9.9 |

Generally, the ABW is slightly higher than the requested bandwidth. This is done to allow for temporary variations in the bit rate of the flow. Even for constant bit rate (CBR) flows, the actual bit rate transmitted over a noisy channel may vary, because of packet retransmissions, collisions, contentions on the channel and other such effects.

As discussed above, the bandwidth reservation request (submitted in R_{B} bytes per R_{I} seconds) is converted to R packets per frame using Equation 1. The R packets can be defined as an X integer portion and a Y fractional or decimal portion, where Y=((R−X)*10) (e.g., R=4.3, where X=4 and Y=3). In one embodiment, the BM utilizes a predefined set of rules in determining the allocation of bandwidth for each frame. The rules allow the reservation of sufficient bandwidth while avoiding floating point operations.

Table 4 below is one example of one implementation for the rules defining the allocation of bandwidth utilized by the BM. Again, X is the whole number portion of the desired number of packets per frame and Y is the decimal portion. The table further provides: the base allocation B; the Increment/Decrement flag (F); the interval (I) defining the number of frames to transmit after which the B is incremented or decremented as defined by F; maximum allocation (A) for a flow; and an effective allocated bandwidth (ABW). The BM further utilizes a transmission counter (TC). In one embodiment, the TC is initialized with the value of the interval I and is decremented before every transmission. When TC reaches zero, the base allocation B (and thus the actual number of packets transmitted) for the frame is incremented (INC) or decremented (DEC) as defined by the increment/decrement flag F. It will be apparent to one skilled in the art that the transmission counter can be implemented in a variety of ways without departing from the novelty of the present invention including incrementing from zero before each transmission until the interval I value is reached, incrementing from 1 after each transmission and determining the value of TC before transmission, and any number of other ways to keep track of the number of transmissions.

TABLE 4
Rules for updating the reservation table

| Request | Y | B | F | I | A | ABW |
|---|---|---|---|---|---|---|
| X.0 | 0 | X | INC | 10 | X + 1 | X.1 |
| X.1 | 1 | X | INC | 5 | X + 1 | X.2 |
| X.2 | 2 | X | INC | 3 | X + 1 | X.33 |
| X.3 | 3 | X | INC | 3 | X + 1 | X.33 |
| X.4 | 4 | X | INC | 2 | X + 1 | X.5 |
| X.5 | 5 | X + 1 | DEC | 3 | X + 1 | X.67 |
| X.6 | 6 | X + 1 | DEC | 3 | X + 1 | X.67 |
| X.7 | 7 | X + 1 | DEC | 4 | X + 1 | X.75 |
| X.8 | 8 | X + 1 | DEC | 10 | X + 1 | X.9 |
| X.9 | 9 | X | INC | 1 | X + 1 | X + 1 |

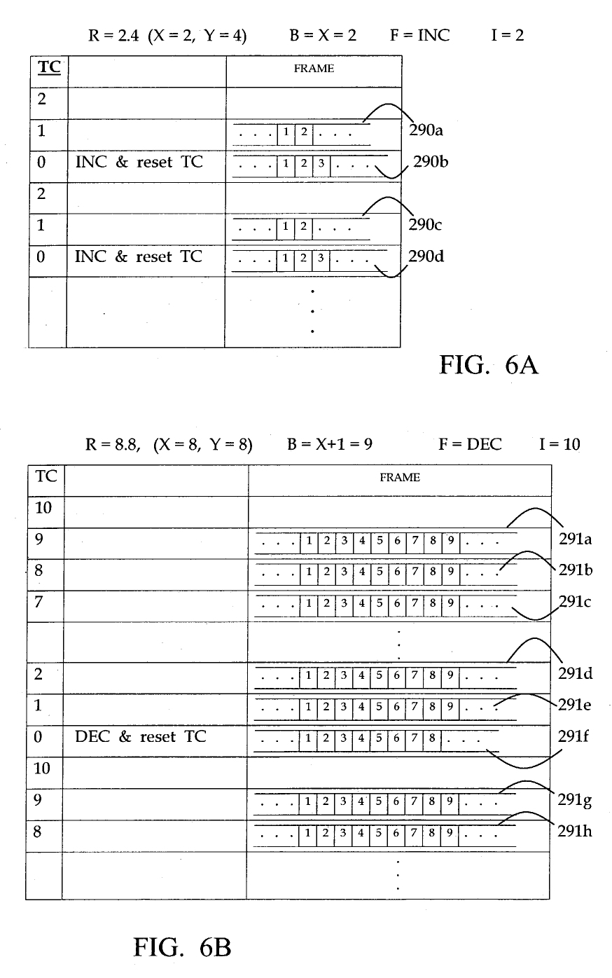

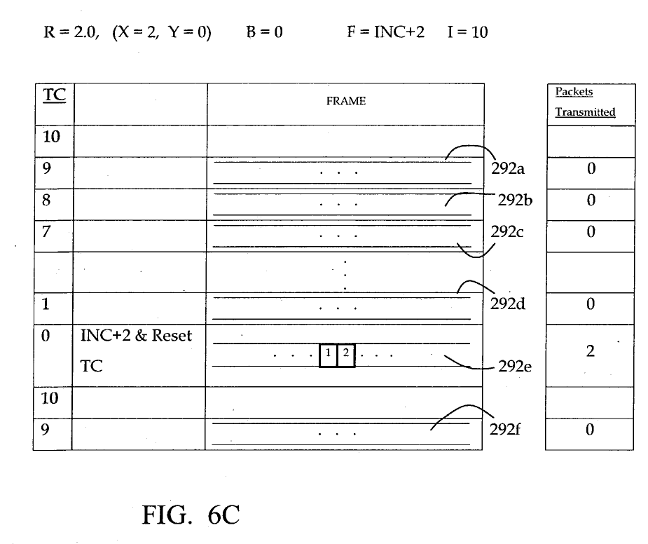

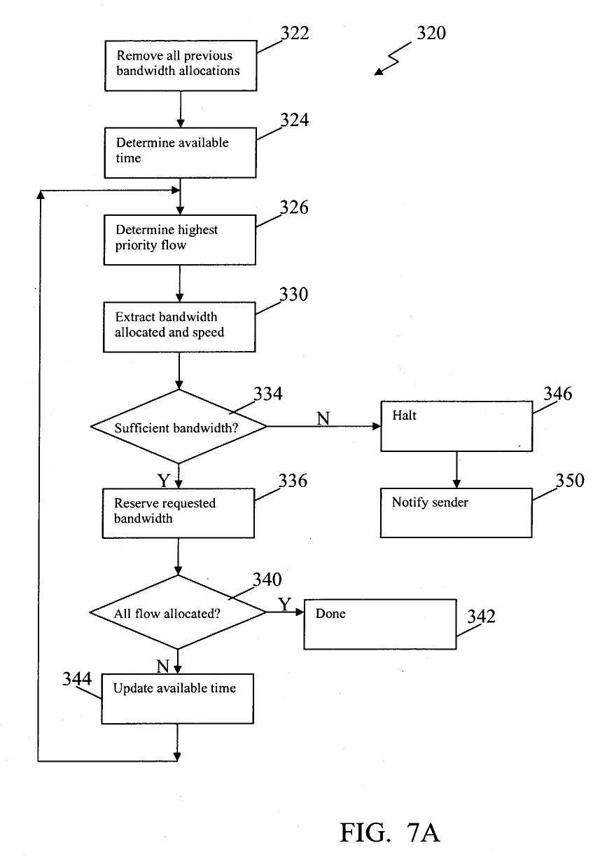

FIG. 6A depicts an example of portions of a plurality of sequential frames 290a-d for a flow being transmitted across a link, where the bandwidth reservation request R equals 2.4 packets per frame, thus X=2, and Y=4. Using to Table 4, for R=2.4, B=X=2, F is set to Increment (INC) (i.e., at TC=0, B=3), and the interval I=2. The transmission counter TC is set to the interval (i.e., TC=2) and is decremented before each transmission. The bandwidth reservation is configured to allow each frame to include 2 packets 290a and 290c (defined by B) until TC equals zero, in this example at every other transmission, and then reserved to transmit 3 packets 290b and 290d.

Previous communication system would round up from 2.4 to 3 packets and always transmit 3 packets per frame, thus wasting 0.6 frames every transmission. The present invention, however, reduces the total wasted bandwidth by at least one packet every two frames.

FIG. 6B depicts an example of portions of a plurality of sequential frames 291a-h for a flow being transmitted across a link, where it is assumed the bandwidth reservation request R equals 8.8 packets per frame, thus X=8, and Y=8. According to Table 4, for R=8.8, B=X+1=9, F is set to decrement (DEC) (i.e., at TC=0, B=8), and the interval I=10. The transmission counter TC is set to the interval (i.e., TC=10) and is decremented before each transmission. The bandwidth reservation is configured to allow each frame to include 9 packets 291a-e and 291g-h (defined by B)-until TC equals zero, at the tenth transmission, and only 8 packets 291f on the tenth transmission.

Previous communication system would round up from 8.8 to 9 packets and always transmit 9 packets per frame, thus wasting 0.2 frames every transmission. The present invention, however, reduces the total wasted bandwidth by at least one packet every ten frames.

The present invention can also schedule one or more packet every Z frames. For example referring to FIG. 6C, if the flow only needs to transmit two packets every tenth frame (Z=10), the network 150 can insert a new entry in the table where the flow is granted a bandwidth with zero packets for frames 292a-d and 292f where TC>0 (where I is set to 10). The flow will further be granted bandwidth that is incremented by two (INC+2) when TC=0, thus providing two packets every tenth frame 292e. In implementing the scheduling of one or more packet every Z frames, the bandwidth reservation table is extended by an increment/decrement Value V, and in the above example V would be set to 2.

The BM is further able to optimize the bandwidth per frame even with the variable packet transmissions of various flows. The BM is further configured to adjust the reserved bandwidths of these variable packets between sequential frames to optimize the use of the frame. For example, if there are two different flows (flowₐ and flow_{b}), each having X.4 packets per frame, the BM would reserve X packets in a first frame and X+1 packets in the next frame for both flows. The BM is configured to be able to adjust the bandwidth allocation to reserve X packets for flowₐ and X+1 packets for flow_{b} in frames, and X+1 packets for flowₐ and X packets for flow_{b} in frameᵢ₊₁, thus maintaining an even number of reserved packets for each frame. This optimizes the number of packets per frame by avoiding the necessity of assigning 2X packets for both flows in frameᵢ and 2(X+1) packets in frameᵢ₊₁. However, the BM could reserve bandwidth for both flows to have 2×packets in frameᵢ if there are one or more other flows which can utilize the additional 2 packets every other frame (i.e., frameᵢ).

The present invention is configured to provide the bandwidth reservation utilizing the allocation rules shown in Table 3, or other similar rules. This process of allocating bandwidth, using the tuple <B,F,I,TC>, allows for a computationally simple bandwidth allocation implementation without performing floating point operations. Thus, improving processing and scheduling of packet transmission and admission control.

In one embodiment, the present invention is capable of verifying the bandwidth reservations for the flows sharing a link and/or reallocating the bandwidth reservations for flows sharing a link in the event that the link speed is altered. The link speed is dictated in part by the quality of the link between the AP 152 and the terminal, and/or between terminals because the quality of the link determines in part the highest speed at which data and/or information can be transmitted over the link. Changes in link speed are reported to the BM. The BM evaluates the flows on the link to verify that the flows are still able to be transmitted in the available time of the frame. In one embodiment, when the speed of a link changes, the BM reallocates bandwidth reservations for the flows on the link by releasing the previously allocated bandwidth reservations and reallocating bandwidth reservations based on the new link speed and the flow priorities.

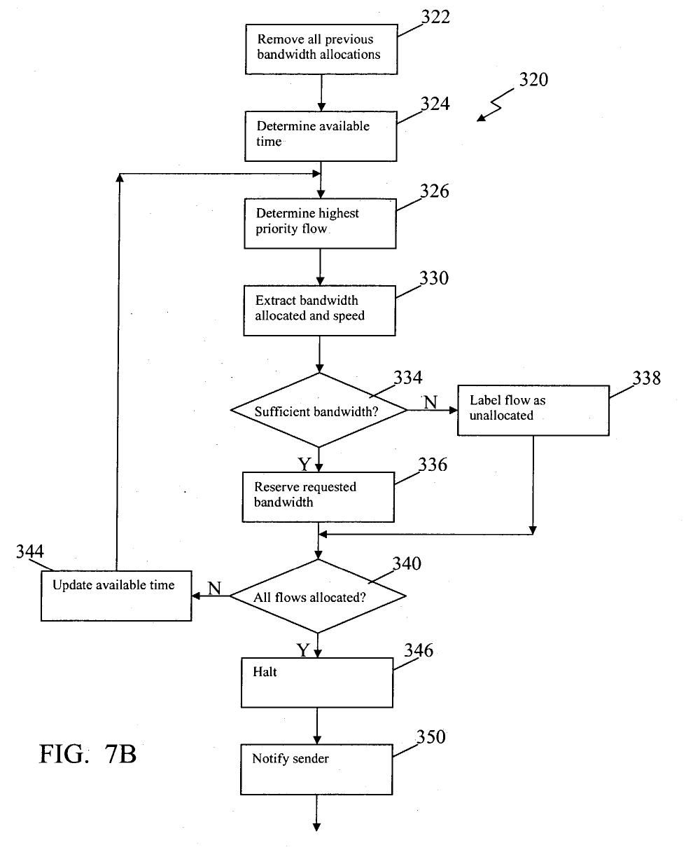

FIG. 7A depicts a flow diagram of one embodiment of a method 320 for reallocating bandwidth for flows utilizing a link which has undergone a change in link speed or change in frame allocation. In step 322, the BM removes previous bandwidth allocations for the flows associated with the link. In step 324, the BM determines the available time in the frame. In step 326, the BM determines the highest priority flow of the flows associated with the link. If there is more than one flow with the same priority, the BM selects the flows based on a random selection, the order in which flows were originally received, other criteria or other such determination. In step 330, the BM extracts the previous bandwidth allocation and the link speed. In step 334, the method determines if there is sufficient bandwidth remaining to accommodate the flow. If there is enough bandwidth, the process proceeds to step 336 where the requested bandwidth is reserved. In step 340, it is determined if all of the flows for the link have been allocated bandwidth. If all of the flows have been evaluated, step 342 is entered and the reallocation is complete. If all of the flows have not been evaluated, step 344 is entered where the available time in the frame is updated. The method 320 then returns to step 326 to get the next highest priority flow for evaluation. If in step 334 it is determined that there is insufficient bandwidth, the reallocation is halted in step 346. In step 350, the senders of the flows that were not reallocated are notified that their bandwidth reservation was released.

FIG. 7B depicts a flow diagram of one embodiment of a method 320 for reallocating bandwidth for flows utilizing a link which has undergone a change in link speed or change in frame allocation similar to that shown in FIG. 7A, however, the method continues to allocate bandwidth as long as bandwidth is available and all the flows requesting bandwidth have not been evaluated. The method in FIG. 7B is the same as that shown in FIG. 7A through step 334. If in step 334 it is determined that there is insufficient bandwidth, the flow is labeled as currently unallocatable in step 338. The process proceeds to step 340 where it is determined if all flows have been evaluated. If all flows have been evaluated, the process proceeds to step 346 where reallocation is halted. In step 350, the senders of flows that were not reallocated are notified that their bandwidth reservation was released. If, in step 340, all of the flows have not been reallocated, the process proceeds to step 344 to update the available time. The method 320 then returns to step 326 to get the next highest priority flow for evaluation.

The present invention additionally provides the ability to enhance communication by improving the initiation of data transmission. Previous communication systems required the central AP to establish a connection with the terminal then submit a bandwidth request and obtain a verification of allocated bandwidth prior to transmitting information over a link. This significantly reduces communication speed because the initiation of data transmission cannot begin until after the bandwidth allocation verification.

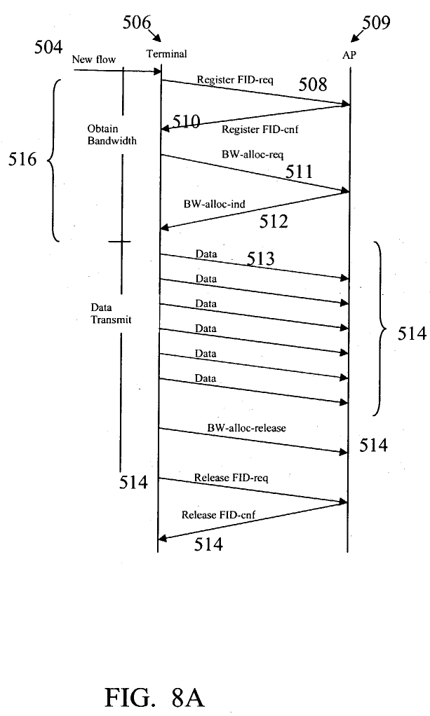

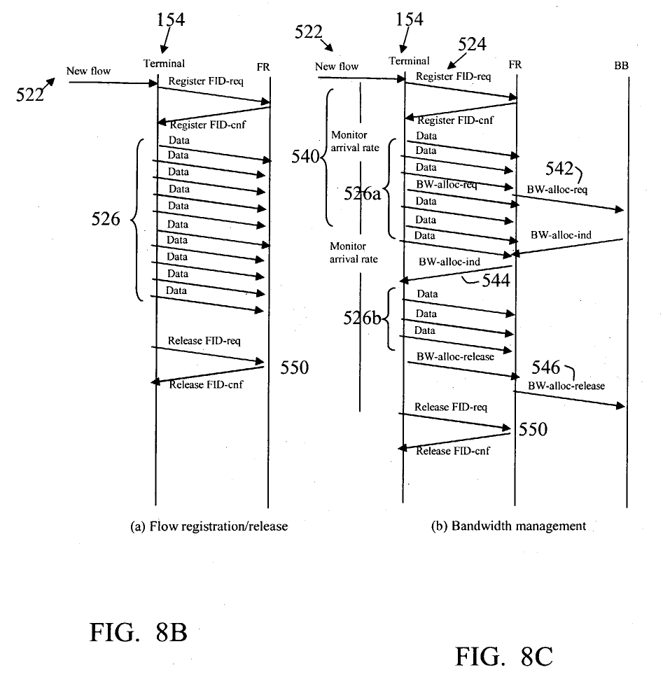

FIG. 8A depicts a graphical representation of the communication of information through a previous system. Upon receiving a flow 504, the terminal 506 characterizes the traffic and submits a flow registration 508 to the central AP 509 and awaits a confirmation 510. The terminal 506 then submits a request for a bandwidth reservation 511 and awaits confirmation of the bandwidth reservation. Once the confirmation of the bandwidth 512 is received, the terminal 506 initiates 513 data transmission and transmits the data 514. Prior to being able to initiate communication 513 and transmit data, previous systems must request bandwidth reservation for a bandwidth sufficient for the data to be transmitted, and must receive a confirmation 512 of reserved bandwidth prior to transmitting data. This confirmation process requires a pre-initiation time 516 which is very time consuming and significantly reduces data transfer rates.

FIGS. 8B-C graphically illustrate examples of the present invention's ability to manage real-time and non-real-time flows. Referring to FIG. 8B, when a new flow 522 is initiated, the terminal 154 registers the flow 524 and is then capable of immediately transmitting the data and/or signal(s) 526. The present invention does not require a reserved bandwidth before transmission. The information is transmitted through a “best effort” type of transmission where the terminal makes a best effort to transmit the information on whatever bandwidth is available in the present or subsequent frames. If the flow is a real-time flow with a known transmission rate, the terminal 154 may also request a bandwidth reservation (not shown) for the flow 522. When the flow 522 becomes inactive, the terminal releases the flow's registration 550.

Referring to FIG. 8C, if the bandwidth of the flow 522 is not known, the terminal 154 receives the flow and registers the flow 524. The data and/or signal(s) can then be transmitted 526a. The FR is further configured to monitor the transmission rate of the flow, and after a given monitoring interval 540 determine an optimal bandwidth for the flow. The FR then submit a request 542 for the desired bandwidth to the BM for the flow 522. If the bandwidth is available the BM forwards a bandwidth reservation confirmation 544. If the arrival rate of the real-time flow 522 changes, the FR may request more bandwidth or request the release of bandwidth depending on whether the arrival rate increases or decreases. The BM is notified and the BM updates the reservation table accordingly if the speed of the link used by the flow changes (as described above). When the flow 522 becomes inactive, the FR 154 signals 546 the BM of the release of the flow's bandwidth and releases the registration 550.

In one embodiment, the present invention allows a variable bit rate flow to use the network's available bandwidth, while a minimum bandwidth is reserved. As such, variable bit rate flows can reserve a minimum rate and use the network's available rate to handle the variations in the bit rate in excess of the minimum rate reserved. For example, if a flow's rate varies over time between 1.5 Mbps and 4.5 Mbps, the terminal can reserve a minimum bit rate, e.g., 1.5 Mbps, to provide communication for at least the minimum. When the flow's rate is greater than the reserved 1.5 Mbps, the terminal tries to use the network's available bandwidth to accommodate the bandwidth in excess of the 1.5 Mbps.

The minimum bandwidth reserved can exceed the minimum bandwidth in an attempt to optimize bandwidth. For example, if a flow's rate varies over time between 1.5 Mbps and 4.5 Mbps, the terminal can reserve a minimum bit rate of 2 Mbps. Because the flow's variation is typically greater than 1.5 Mbps, the 2 Mbps provides a more optimum utilization of bandwidth. When the flow's rate is less than 2 Mbps, some bandwidth may be wasted, but this may be a small percentage of the time. Again, when the flow's rate is more than 2 Mbps, the terminal uses the network's available bandwidth to accommodate the extra bandwidth when the flow rate exceeds the 2 Mbps. Other minimum bandwidths can be utilized based on the variation in attempts to optimize bandwidth usage.

In one embodiment, the present invention provides adaptive bandwidth reservation for some types of variable bit rate flows. Initially, a minimum bandwidth is reserved for the variable bit rate flow. Following the receipt of a reservation confirmation, flow variables are updated. The flow variables can include flow queue occupancy (Q_{base}) which is typically based on the number of packets to be communicated, and a reservation time (T_{Base}) based on the allocated time for the reserved bandwidth.

Once a bandwidth is reserved, successive resource requests for the flow are evaluated to determine if the current resource needs differ from the reserved resources. If the current resource needs differ from the reserved resources, an adjustment in the resources requested can be made based on the difference. In one embodiment, the difference between current resource needs and reserved resources must differ by a predefined threshold (Q_{threshold}) before adjustments in the requested resources are implemented.

For example, initial reserved resources can provide a flow queue occupancy of Q_{base} and a reservation time T_{base}. Upon the next submission of a resource request the current flow queue occupancy Q_{current} is compared with the reserved queue occupancy Q_{base}. If Q_{current}>Q_{base}+Q_{threshold}, the amount of bandwidth requested is increased by (Q_{current}−Q_{base})/(T_{current}−T_{base}). Upon receipt of the reserved bandwidth confirmation, the flow variables are updated, for example, Q_{base} and the T_{base} are updated according to the new reserved resources.

When a following resource request is to be submitted, the current resource needs are again compared with the reserved resources. If the current flow queue occupancy Q_{current} is less than the reserved queue occupancy Q_{base} by the threshold (i.e., Q_{current}+Q_{threshold}<Q_{base}), then the amount of reserved bandwidth requested can be decreased by Q_{base}/(T_{current}-T_{base}). As such, the present invention provides bandwidth reservations that are adapted based on the current bandwidth needs. These adaptations to the reserved bandwidth can be performed every time bandwidth confirmations are received. Alternatively, these adaptations can be performed periodically, randomly or on some schedule.

While the invention herein disclosed has been described by means of specific embodiments and applications thereof, numerous modifications and variations could be made thereto by those skilled in the art without departing from the scope of the invention set forth in the claims.

What is claimed is:

1. A method used for allocating resources in a communication network, comprising the steps of:
distributing admission control for a communication network;
receiving a new flow at a terminal;
the terminal determining an amount of available resources;
accepting the new flow if there is sufficient available resources;
denying the new flow if there is insufficient available resources; and
managing a bandwidth for flows of the communication network from an access point.

2. The method as claimed in claim 1, further comprising the step of:
limiting a number of flows of a terminal based on traffic loads of the terminal.

3. The method as claimed in claim 1, wherein the step of managing the bandwidth further comprising reserving bandwidth for one or more flows.

4. The method as claimed in claim 3, wherein the step of reserving bandwidth further comprising reserving the bandwidth based on the priority of the one or more flows.

5. The method as claimed in claim 3, wherein the step of managing the bandwidth further comprising reallocating the bandwidth for the one or more flows when the new flow is received and the new flow has a higher priority than at least one of the one or more flows.

6. The method as claimed in claim 3, wherein the step of managing the bandwidth further comprising reallocating the bandwidth of at least one of the one or more flows if a link speed is altered.

7. The method as claimed in claim 1, further comprising the steps of:
transmitting the new flow across a link;
submitting a bandwidth reservation request;
receiving a bandwidth confirmation for a reserved bandwidth; and
transmitting the new flow across the link according to the reserved bandwidth.

8. The method as claimed in claim 7, further comprising the steps of:
monitoring the new flow prior to the step of submitting the bandwidth reservation request;
determining an optimal bandwidth for the new flow; and
the step of submitting the bandwidth reservation request including submitting the bandwidth reservation request for the optimal bandwidth.

9. The method as claimed in claim 7, further comprising the steps of:
prior to the step of submitting the bandwidth reservation request, determining an optimal bandwidth for the new flow based on a known transmission rate; and
the step of submitting the bandwidth reservation request including submitting the bandwidth reservation request for the optimal bandwidth.

10. The method as claimed in claim 1, further comprising the steps of:
determining if a current amount of resources differs from an amount of reserved resources; and
adapting an amount of bandwidth reserved if the current amount of resources differs from the amount of reserved resources.

11. A method used for providing distributed admission control, comprising the steps of:
receiving a bandwidth reservation request;
determining a requested amount of bandwidth needed to satisfy the bandwidth request;
determining an amount of available bandwidth; and
reserving the requested amount of bandwidth without floating point operations.

12. The method as claimed in claim 11, further comprising the steps of:
prior to the step of reserving the requested amount of bandwidth, determining a priority of a first flow;
determining if at least a second flow of one or more flows having bandwidths reserved has a lower priority than the priority of the first flow; and
releasing a first amount of reserved bandwidth reserved for the second flow having the lower priority than the priority of the first flow.

13. The method as claimed in claim 12, further comprising the steps of:
following the step of releasing the first amount of reserved bandwidth, redetermining an amount of available bandwidth;
determining if at least a third flow of the one or more flows having bandwidths reserved has a lower priority than the priority of the first flow if the bandwidth is not available to satisfy the bandwidth reservation request; and
releasing a second amount of reserved bandwidth reserved for the third flow having a lower priority than the priority of the first flow.

14. The method as claimed in claim 11, wherein the step of determining a requested amount of bandwidth needed to satisfy the bandwidth request including allocating a variable bandwidth where the bandwidth in a first frame is different from a bandwidth in a second frame.

15. The method as claimed in claim 14, further comprising the steps of:
receiving the bandwidth request as a number of bytes per second and converting the request to a number of packets per frame; and
utilizing the number packets per frame to determine a base allocation and an interval value without floating point operations.

16. The method as claimed in claim 15, further comprising the step of:
utilizing the interval value in initializing the first and second frames.

17. A method for providing communication control, comprising the steps of:
releasing a plurality of bandwidth reservations for a plurality of flows being transmitted over a first link if a first link speed of the first link changes to a second link speed;
determining an available amount of bandwidth based on the second link speed; and
reserving bandwidth for at least some of the plurality of flows for transmission over the first link at the second link speed.

18. The method as claimed in claim 17, wherein the step of reserving bandwidth further comprising:
determining the priority of each of the plurality of flows; and
reserving bandwidth for each of the plurality of flows in order of the highest priority flow to the lowest priority flow until the amount of available bandwidth is less than a bandwidth for each of the plurality of flows not having a reserved bandwidth or each of the plurality of flows have a reserved bandwidth.

19. An admission control apparatus, comprising:
a bandwidth manager (BM) coupled with one or more flow registration units (FR), wherein at least one of the one or more FRs is positioned a distance from the BM;
the BM being configured to allocate bandwidth to one or more flows communicating data over a communication network; and
the one or more FRs being configured to perform one of accepting and denying one or more new flows attempting to utilize the communication network.

20. The apparatus as claimed in claim 19, wherein the one or more FRs is configured to accept or deny the one or more new flows based on traffic load.

21. The apparatus as claimed in claim 19, wherein the one or more FRs is configured to submit bandwidth reservation requests to the BM.

22. The apparatus as claimed in claim 21, wherein the BM is configured to reserve bandwidth based on the reservation requests.

23. The apparatus as claimed in claim 22, further comprising:
the one or more flows each having a priority; and
the BM being configured to release a first amount of bandwidth reserved for a first flow and reserve at least a portion of the first amount of bandwidth for a second flow, where the second flow has a higher priority than the first flow.

24. The apparatus as claimed in claim 19, further comprising:
the bandwidth manager (BM) being configured to allocate bandwidth for one or more communication flows across the network;
the BM being coupled with a first end of a first link configured to provide a communication link for at least one of the one or more flows; and
a second end of the first link being coupled with a first flow registration unit (FR) configured to allocate network resources to a first flow of the one or more flows, where the first FR is positioned geographically distance from the BM.

25. The apparatus as claimed in claim 24, further comprising:
a first end of a second link being coupled with the BM; and
a second end of the second link being coupled with a second FR configured to allocate network resources to a second flow of the one or more flows, where the second FR is positioned geographically distance from both the BM and the first FR.

26. The apparatus as claimed in claim 25, further comprising:
a first end of a third link being coupled with the first FR and a second end of the third link being coupled with the second FR, wherein a third flow is communicated across the third link.

27. The apparatus as claimed in claim 24, wherein the BM being configured to free up bandwidth to satisfy the bandwidth request for the first amount of bandwidth.

28. An apparatus for providing a distributed communication network communication, comprising:
an access point being coupled with one or more terminals, wherein at least one of the one or more terminals is positioned geographically distant from the access point;
the access point having a bandwidth manager (BM) configured to receive bandwidth requests and to reserve bandwidth based on the requests; and
at least one of the one or more terminals having a flow registration unit (FR) configured to allocate network resources to one or more flows and to limit the number of flows based on traffic load.

29. The apparatus as claimed in claim 28, further comprising:
the access point being coupled with a first end of a first link configured to provide a communication path for at least one of the one or more flows; and
a second end of the first link being coupled with a first terminal of the one or more terminals, wherein the first terminal includes a first FR being configured to determine if there is sufficient resources available in the first terminal to accept a new flow.

30. The apparatus as claimed in claim 29, wherein the first FR being configured to check at least one of the available memory and the number of packets waiting for transmission from the first terminal in determining the available resources.

31. The apparatus as claimed in claim 29, wherein the first FR being configured to submit a bandwidth reservation request to the BM for a bandwidth to satisfy the bandwidth needs of the new flow.
